(19) United States
(12) Patent Application Publication
(10) Pub. No.: US 2023/0081970 A1
(43) Pub. Date: Mar. 16, 2023

(54) DATA ANALYSIS SYSTEM, DATA ANALYSIS METHOD, AND COMPUTER PROGRAM

(71) Applicant: SHIMADZU CORPORATION, Kyoto (JP)

(72) Inventor: Tomohiro KAWASE, Kyoto (JP)

(21) Appl. No.: 17/888,644

(22) Filed: Aug. 16, 2022

(30) Foreign Application Priority Data
Sep. 10, 2021 (JP) 2021-147904

(51) Int. Cl. G06F 7/544

(52) U.S. Cl. CPC G06F 7/544

(57) ABSTRACT

A data storage part (2) that stores responses, which are a plurality of analysis results obtained by a plurality of analyses executed under a plurality of analysis conditions, and factors, which are a plurality of parameters included in the analysis conditions, in a manner that the responses and the factors are associated with each other, a data processor (4) configured to use at least one of the factors as a variable and to create an approximate expression indicating a relationship between the variable and the responses, and an information input device (6) for a user to input information to the data processor (4). The data processor (4) is configured to execute a variable setting step of causing the user to set at least one of the factors to be the variable, a structure setting step of causing the user to optionally set a structure of a model expression that is a basis of the approximate expression using the variable set in the variable setting step, a model expression determination step of determining the model expression based on the structure set by the user in the structure setting step, and an approximate expression determination step of determining a coefficient of each term constituting the model expression determined in the model expression determination step by regression analysis, and thereby determining the approximate expression.

### BACKGROUND OF THE INVENTION

### 1. Field of the Invention

The present invention relates to a data analysis system, a data analysis method, and a computer program for analyzing a relationship between an analysis condition and an analysis result obtained by performing analysis such as liquid chromatography analysis under a plurality of analysis conditions.

### 2. Description of the Related Art

In a pharmaceutical field and the like, an analysis method such as liquid chromatography analysis is used to check impurities mixed during production and the like. At that time, since it is necessary to detect as many components as possible contained in a target substance, it is necessary to search for an “optimal analysis condition” in which more component peaks appear in a chromatogram. In order to search for the “optimal analysis condition”, it is necessary to consider all analysis conditions in which a plurality of parameters such as a flow rate of a mobile phase, a temperature of a separation column, and a composition of a mobile phase (a mixing ratio of solvents constituting the mobile phase) are varied, but it takes a huge amount of time to perform analysis under all analysis conditions to acquire data. In view of the above, a method of approximating a relationship between an analysis condition and an analysis result using regression analysis and searching for the “optimal analysis condition” using an approximation result may be employed.

### SUMMARY OF THE INVENTION

In a method using regression analysis, each parameter of an analysis condition is set a factor, an analysis result (degree of separation of a peak in chromatogram, the number of peaks, retention time of each peak, and the like) under each analysis condition is set as a response, and an approximate expression approximating a relationship between the factor and the response is created. In order to create an approximate expression, it is necessary to first prepare a model expression that is a basis of the approximate expression. When the model expression is set, a coefficient of each of terms constituting the model expression is determined by regression analysis using the least squares method or the like.

In a conventional analysis system, an approximate expression is created by determining a coefficient of each operation term by the least squares method or the like on the basis of a predetermined model expression. However, in recent studies, it has been found that some types of analysis condition parameters have a relationship with an analysis result that is not expressed by a predetermined model formula. Therefore, regression analysis based on a predetermined model expression cannot derive an accurate approximate expression indicating a relationship between an analysis condition including such a parameter and an analysis result.

The present invention has been made in view of the above problem, and an object of the present invention is to increase the degree of freedom in constructing a model expression that is a basis of regression analysis and to increase the accuracy of an approximate expression to be derived.

A data analysis system according to the present invention includes a data storage part that stores responses, which are a plurality of analysis results obtained by a plurality of analyses executed under a plurality of analysis conditions, and factors, which are a plurality of parameters included in the analysis conditions, in a manner that the responses and the factors are associated with each other, a data processor configured to use at least one of the factors as a variable and to create an approximate expression indicating a relationship between the variable and the responses, and an information input device for a user to input information to the data processor. The data processor is configured to execute a variable setting step of causing the user to set at least one of the factors to be the variable, a structure setting step of causing the user to optionally set a structure of a model expression that is a basis of the approximate expression using the variable set in the variable setting step, a model expression determination step of determining the model expression based on the structure set by the user in the structure setting step, and an approximate expression determination step of determining a coefficient of each term constituting the model expression determined in the model expression determination step by regression analysis, and thereby determining the approximate expression.

A data analysis method according to the present invention includes an analysis data preparing step of preparing responses, which are a plurality of analysis results obtained by a plurality of analyses executed under a plurality of analysis conditions, and factors, which are a plurality of parameters included in the analysis conditions, in a state where the responses and the factors are associated with each other, a variable setting step of optionally setting at least one of the factors as a variable, a structure setting step of optionally setting a structure of a model expression that is a basis of an approximate expression showing a relationship between the response and the variable by using the variable set in the variable setting step, a model expression determination step of determining the model expression based on the structure set in the structure setting step, and an approximate expression determination step of determining a coefficient of each term constituting the model expression determined in the model expression determination step by regression analysis, and thereby determining the approximate expression.

A data analysis system according to the present invention is configured to cause the user to set at least one parameter as a variable among a plurality of parameters included in an analysis condition, and to cause the user to optionally set a structure of a model expression that is a basis of an approximate expression using the set variable. Therefore, the degree of freedom in constructing a model expression that is a basis of regression analysis is improved, and accuracy of a derived approximate expression is improved.

In the data analysis method according to the present invention, at least one parameter as a variable among a plurality of parameters included in an analysis condition is optionally set, and a structure of a model expression that is a basis of an approximate expression is optionally set with the analysis result as a response by using the set variable. Therefore, the degree of freedom in the construction of a model expression that is a basis of regression analysis is improved, and the accuracy of a derived approximate expression is improved.

### BRIEF DESCRIPTION OF THE DRAWINGS

FIG. 1 is a flowchart illustrating an embodiment of a data analysis method;

FIG. 2 is a block diagram illustrating an example of a configuration of a data analysis system that executes the data analysis method;

FIG. 3 is an example of a setting screen of a model expression; and

FIG. 4 is an example of a detailed setting screen of a model expression.

### DETAILED DESCRIPTION OF THE INVENTION

Hereinafter, an embodiment of a data analysis system and a data analysis method will be described with reference to the drawings.

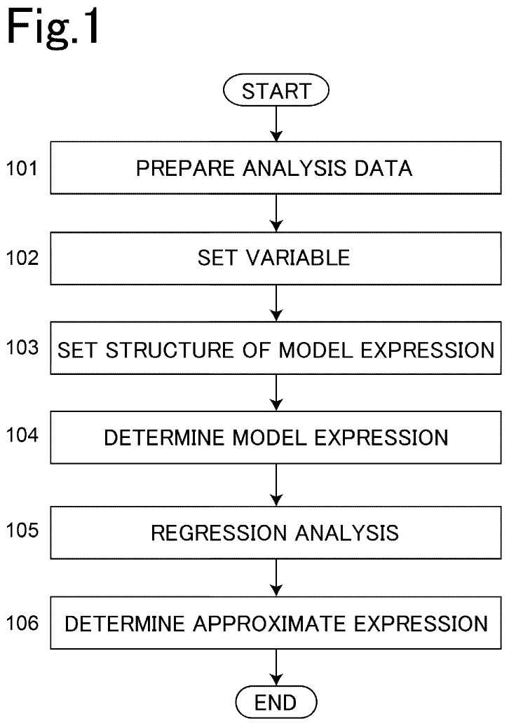

First, the data analysis method of this embodiment will be described with reference to a flowchart of FIG. 1.

First, analysis data to be used for regression analysis is prepared (Step 101). The analysis data is obtained by associating an analysis result (for example, the degree of separation of peaks in a chromatogram, the number of peaks, retention time of each peak, and the like) obtained by changing a plurality of parameters (for example, a flow rate of a mobile phase, a temperature of a column oven, composition of a mobile phase solvent, a mixing ratio of a mobile phase solvent, a gradient method, a sample injection amount, and the like) of an analysis condition for each analysis for the same sample with each parameter of each analysis condition. In the regression analysis, an analysis result obtained by analysis is defined as a “response”, and each parameter of an analysis condition is defined as a “factor”.

Next, based on prepared analysis data, a factor to be a variable in an approximate expression to be created is selected and set from among parameters of an analysis condition (Step 102). In setting of a variable, any one or more parameters among a plurality of parameters included in an analysis condition can be set as a variable. After setting a variable, a structure of a model expression on which an approximate equation indicating a relationship between a variable and a response is based is set (Step 103). The structure of a model expression can also be optionally set. For example, an existing structure in which only four arithmetic operations such as a linear equation and a quadratic equation are used can be employed as the structure of a model expression, or a new structure incorporating optional operation such as a square root, a power of a variable, an exponential function, and a logarithmic function can be employed as the structure of a model expression.

After the structure of a model expression is set, a model expression is determined based on the set structure (Step 104). The model expression is an expression including a sum of coefficient-indefinite terms using a variable. After determining the model expression, a coefficient of each of terms in the model expression is determined by regression analysis. In this manner, an approximate expression is determined (Steps 105 and 106). As the regression analysis used to determine a coefficient of each of terms, Bayesian inference or the like can be used in addition to the least squares method. A method of the regression analysis may be optionally set by the user. After an approximate expression is determined by regression analysis, processing such as drawing an approximate curve can be executed.

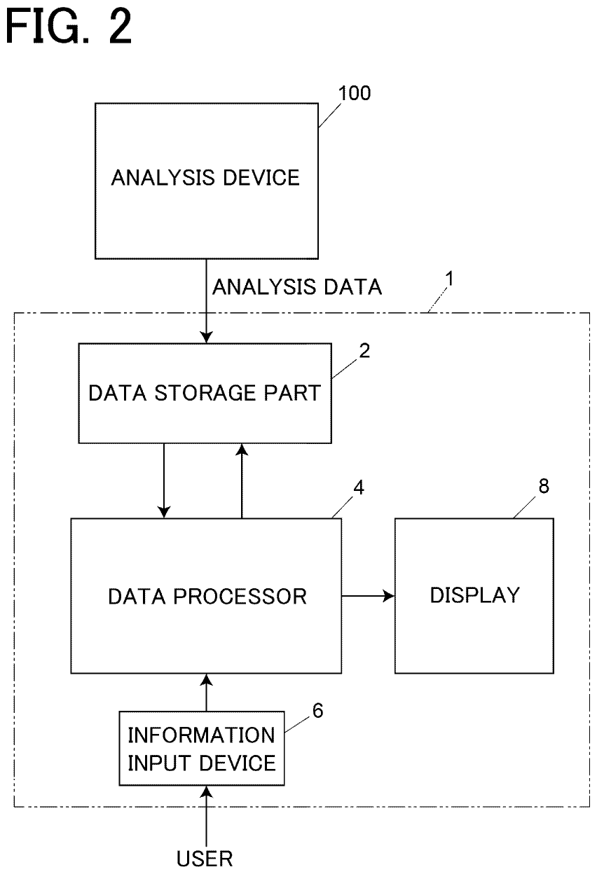

An example of a configuration of a data analysis system for executing the above data analysis method is shown in FIG. 2.

A data analysis system 1 is realized by an electronic computer in which a computer program for performing the above-described data analysis method is installed, and includes a data storage part 2, a data processor 4, an information input device 6, and a display 8.

The data storage part 2 is a storage area for storing analysis data obtained by an analysis device 100, and is realized by a partial area of an information storage device such as a hard disk drive. The analysis device 100 is, for example, a liquid chromatograph. The data processor 4 performs analysis by the above-described data analysis method on analysis data stored in the data storage part 2. The information input device 6 and the display 8 are connected to the data processor 4. The information input device 6 is realized by a keyboard, a mouse, or the like, and the user can input information to the data processor 4 through the information input device 6. Information to be presented to the user is output from the data processor 4 to the display 8 as necessary, and is displayed on the display 8.

When executing regression analysis using the data analysis system 1, the user identifies analysis data as a target of the regression analysis from among pieces of data stored in the data storage part 2 (preparation of analysis data). When analysis data as a target of regression analysis is identified, the data processor 4 displays a model expression setting screen for setting a model expression on the display 8, and displays information necessary for setting the model expression on the model expression setting screen.

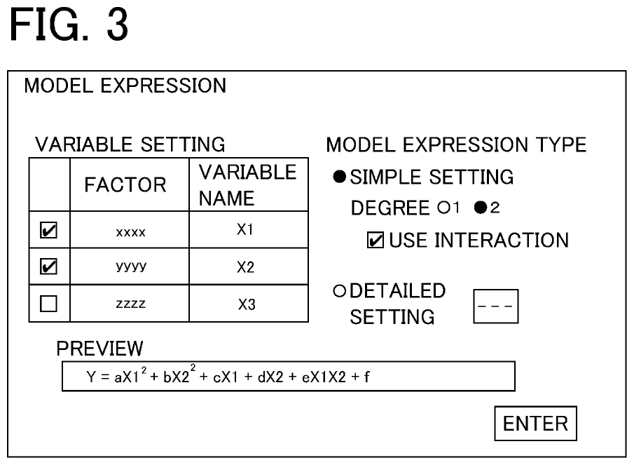

FIG. 3 is an example of the model expression setting screen. In this example, a variable setting field, a model expression type setting field, and a preview field are provided in the model expression setting screen.

In the variable setting field, factors (parameters included in an analysis condition) that can be set as a variable are listed. The user can optionally select one or more factors to be variables in the approximate expression. In this example, two factors are selected, and the factors are set to be variables X1 and X2.

In the model expression type setting field, a structure of a model expression can be set. In this example, simple setting and detailed setting can be selected. In the simple setting, the maximum degrees 1 and 2 of the model expression are prepared as options of a structure of a model expression, and the user can easily set a structure of a model expression of a linear equation or a quadratic equation by selecting one of the maximum degrees. Furthermore, in the simple setting, it is possible to select whether or not to incorporate an interaction in a model expression, and the user can easily set a structure of a model expression using an interaction.

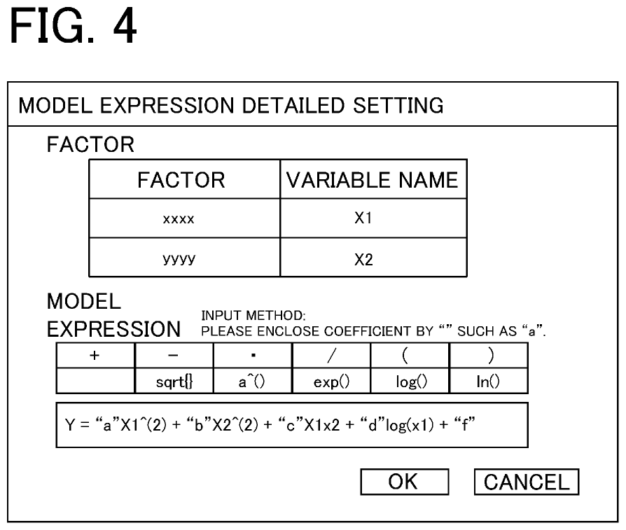

When the user selects detailed setting in the model expression type setting field, the data processor 4 executes a model expression optional setting mode and displays a model expression detailed setting screen as illustrated in FIG. 4 on the display 8. On the model expression detailed setting screen, options of operation terms such as a square root, a power of a coefficient, an exponential function, and a logarithmic function are prepared in addition to four arithmetic operations, and the user can set a structure of an optional model expression using an optional operation term among these options.

The data processor 4 is configured to create a model expression having a structure set by the simple setting or the detailed setting and display the model expression in the preview field. In the example of FIG. 3, the model expression “Y=aX1²+bX2+cX1+dX2+f” in a case where the maximum degree is set to 2 and an interaction is set to be used in the simple setting is displayed. In the model expression, X1 and X2 are variables (factors), Y is a response, and a to f are coefficients of each term.

The user checks the model expression displayed in the preview field, and inputs an instruction to determine the model expression to the data processor 4 when executing regression analysis with the model expression. In this manner, a model expression on which regression analysis is based is determined. In the example of FIG. 3, an “Enter” button is arranged at the lower right, and an instruction to determine the model expression is input to the data processor 4 as the “Enter” button is pressed (for example, the user places a cursor on the Enter button with a mouse and clicks the Enter button).

When a model expression is determined, the data processor 4 determines coefficients (a, b, c, d, and f in FIGS. 3 and 4) of terms constituting the model expression using a regression analysis method such as the least squares method. In the regression analysis, fine adjustment of the coefficient is repeated such that the value Y of a response calculated by applying each factor to each variable of the model expression approaches a value of an actual response, and a coefficient when the calculated value Y of the response most approximates the value of the actual response is obtained. By determining the coefficients of the terms of the model expression, an approximate expression approximating a relationship of the factors to the response is determined.

After an approximate expression is determined, the data processor 4 can have a function of drawing an approximate line or the like based on the approximate expression and displaying the approximate line or the like on the display 8. The user can perform processing of determining an optimum analysis condition of a target sample on the basis of information such as an approximate line displayed on the display 8.

Note that the embodiment described above is merely an example of embodiments of the data analysis system, the data analysis method, and the computer program according to the present invention. The embodiment of the data analysis system, the data analysis method, and the computer program according to the present invention is as described below.

An embodiment of a data analysis system according to the present invention includes a data storage part that stores responses, which are a plurality of analysis results obtained by a plurality of analyses executed under a plurality of analysis conditions, and factors, which are a plurality of parameters included in the analysis conditions, in a manner that the responses and the factors are associated with each other, a data processor configured to use at least one of the factors as a variable and to create an approximate expression indicating a relationship between the variable and the responses, and an information input device for a user to input information to the data processor. The data processor is configured to execute a variable setting step of causing the user to set at least one of the factors as the variable, a structure setting step of causing the user to optionally set a structure of a model expression that is a basis of the approximate expression using the variable set in the variable setting step, a model expression determination step of determining the model expression based on the structure set by the user in the structure setting step, and an approximate expression determination step of determining a coefficient of each term constituting the model expression determined in the model expression determination step by regression analysis, and thereby determining the approximate expression.

In a first aspect of the embodiment of the data analysis system, a display electrically connected to the data processor is included. In the structure setting step, the data processor is configured to display options of a structure of the model expression and/or options of a term to be incorporated into the model expression on the display, and to require the user to optionally select the options, so as to requiring the user to set a structure of the model expression. According to such an aspect, the user can easily set a model expression having an optional structure.

In the first aspect, the data processor is configured to be able to execute a model expression optional setting mode for the user to input a structure of the model expression that is optional in the structure setting step. In this manner, there is no limitation on a structure of a model expression, and even in a case where a new relationship between a factor and a response is found, it is possible to create an approximate equation in consideration of such a relationship.

Further, in the first aspect, the data processor is configured to display a preview of a model expression of a structure set by the user on the display in the structure setting step. According to such an aspect, the user can check a model expression of a structure set by the user, and can prevent a model expression of an incorrect structure from being created.

In a second aspect of the embodiment of the data analysis system, the analysis is liquid chromatography analysis, the analysis result is any of the number of peaks in a chromatogram, the degree of separation of peaks in the chromatogram, and retention time of a peak appearing in the chromatogram, and the analysis condition includes, as the parameter, at least one of a type of one or more solvents constituting a mobile phase, a flow rate of each of one or more of the solvents, a temperature of a separation column, and a sample injection amount. This second aspect can be combined with the first aspect.

In a third aspect of the embodiment of the data analysis system, the regression analysis is the least squares method. This third aspect can be combined with the first aspect and/or the second aspect described above.

In a fourth aspect of the embodiment of the data analysis system, the regression analysis is Bayesian inference. This fourth aspect can be combined with the first aspect and/or the second aspect described above.

An embodiment of a data analysis method according to the present invention includes an analysis data preparing step of preparing responses, which are a plurality of analysis results obtained by a plurality of analyses executed under a plurality of analysis conditions, and factors, which are a plurality of parameters included in the analysis conditions, in a state where the responses and the factors are associated with each other, a variable setting step of optionally setting at least one of the factors as a variable, a structure setting step of optionally setting a structure of a model expression that is a basis of an approximate expression showing a relationship between the response and the variable by using the variable set in the variable setting step, a model expression determination step of determining the model expression based on the structure set in the structure setting step, and an approximate expression determination step of determining a coefficient of each term constituting the model expression determined in the model expression determination step by regression analysis, so that the approximate expression is determined.

In a first aspect of the embodiment of the data analysis method, in the structure setting step, a structure of the model expression is set using a structure and/or a term selected from a plurality of options for a structure of the model expression prepared in advance and/or a plurality of options for a term to be incorporated into the model expression prepared in advance. According to such an aspect, a model expression having an optional structure can be easily set.

In the first aspect, a structure of the model expression that is optional is created in the structure setting step. In this manner, there is no limitation on a structure of a model expression, and even in a case where a new relationship between a factor and a response is found, it is possible to create an approximate equation in consideration of such a relationship.

In a second aspect of the embodiment of the data analysis method, the analysis is liquid chromatography analysis, the analysis result is any of the number of peaks in a chromatogram, the degree of separation of peaks in the chromatogram, and retention time of a peak appearing in the chromatogram, and the analysis condition includes, as the parameter, at least one of a type of one or more solvents constituting a mobile phase, a flow rate of each of one or more of the solvents, a temperature of a separation column, and a sample injection amount. This second aspect can be combined with the first aspect.

In a third aspect of the embodiment of the data analysis method, the regression analysis is the least squares method. This third aspect can be combined with the first aspect and/or the second aspect described above.

In a fourth aspect of the embodiment of the data analysis method, the regression analysis is Bayesian inference. This fourth aspect can be combined with the first aspect and/or the second aspect described above.

In an embodiment of a computer program according to the present invention, the data analysis method is configured to be executed by being executed on a computer.

### DESCRIPTION OF REFERENCE SIGNS

1 data analysis system
2 data storage part
4 data processor
6 information input device
8 display

What is claimed is:

1. A data analysis system comprising:
a data storage part that stores responses, which are a plurality of analysis results obtained by a plurality of analyses executed under a plurality of analysis conditions, and factors, which are a plurality of parameters included in the analysis conditions, in a manner that the responses and the factors are associated with each other;
a data processor configured to use at least one of the factors as a variable and to create an approximate expression indicating a relationship between the variable and the responses; and
an information input device for a user to input information to the data processor,
wherein the data processor is configured to execute:
a variable setting step of causing a user to set at least one of the factors as the variable;
a structure setting step of causing a user to optionally set a structure of a model expression that is a basis of the approximate expression using the variable set in the variable setting step;
a model expression determination step of determining the model expression based on the structure set by a user in the structure setting step; and
an approximate expression determination step of determining a coefficient of each term constituting the model expression determined in the model expression determination step by regression analysis, and thereby determining the approximate expression.

2. The data analysis system according to claim 1, further comprising:
a display electrically connected to the data processor,
wherein in the structure setting step, the data processor is configured to display options of a structure of the model expression and/or options of a term to be incorporated into the model expression on the display, and to require a user to optionally select the options, thereby requiring the user to set a structure of the model expression.

3. The data analysis system according to claim 2, wherein a structure of the model expression includes at least one term of four arithmetic operations.

4. The data analysis system according to claim 2, wherein the structure of the model expression includes at least one term of any one of a square root, a power, an exponential function, and a logarithmic function.

5. The data analysis system according to claim 2, wherein the data processor is configured to be able to execute a model expression optional setting mode for a user to input a structure of the model expression that is optional in the structure setting step.

6. The data analysis system according to claim 2, wherein the data processor is configured to display a preview of a model expression of a structure set by a user on the display in the structure setting step.

7. The data analysis system according to claim 1, wherein
the analysis is liquid chromatography analysis,
the analysis result is any of number of peaks in a chromatogram, degree of separation of peaks in the chromatogram, and retention time of a peak appearing in the chromatogram, and
the analysis condition includes, as the parameter, at least one of a type of one or more solvents constituting a mobile phase, a flow rate of each of the one or more solvents, a temperature of a separation column, and a sample injection amount.

8. The data analysis system according to claim 1, wherein the regression analysis is a least squares method.

9. The data analysis system according to claim 1, wherein the regression analysis is Bayesian inference.

10. A data analysis method comprising:
an analysis data preparing step of preparing responses, which are a plurality of analysis results obtained by a plurality of analyses executed under a plurality of analysis conditions, and factors, which are a plurality of parameters included in the analysis conditions, in a state where the responses and the factors are associated with each other;
a variable setting step of optionally setting at least one of the factors as a variable;
a structure setting step of optionally setting a structure of a model expression that is a basis of an approximate expression showing a relationship between the response and the variable by using the variable set in the variable setting step;
a model expression determination step of determining the model expression based on the structure set in the structure setting step; and
an approximate expression determination step of determining a coefficient of each term constituting the model expression determined in the model expression determination step by regression analysis, and thereby determining the approximate expression.

11. The data analysis method according to claim 10, wherein in the structure setting step, a structure of the model expression is set using a structure and/or a term selected from a plurality of options for a structure of the model expression prepared in advance and/or a plurality of options for a term to be incorporated into the model expression prepared in advance.

12. The data analysis method according to claim 10, wherein a structure of the model expression that is optional is created in the structure setting step.

13. The data analysis method according to claim 12, wherein the structure includes at least one term of four arithmetic operations.

14. The data analysis method according to claim 12, wherein the structure includes at least one term of any of a square root, a power, an exponential function, and a logarithmic function.

15. The data analysis method according to claim 10, wherein
the analysis is liquid chromatography analysis,
the analysis result is any of number of peaks in a chromatogram, degree of separation of peaks in the chromatogram, and retention time of a peak appearing in the chromatogram, and
the analysis condition includes, as the parameter, at least one of a type of one or more solvents constituting a mobile phase, a flow rate of each of the one or more solvents, a temperature of a separation column, and a sample injection amount.

16. The data analysis method according to claim 10, wherein the regression analysis is a least squares method.

17. The data analysis method according to claim 10, wherein the regression analysis is Bayesian inference.

18. A computer program configured to execute the data analysis method according to claim 10 by being executed on a computer.
